(19) United States
(12) Patent Application Publication
(10) Pub. No.: US 2004/0183783 A1
(43) Pub. Date: Sep. 23, 2004

(54) Method and apparatus for improved keyboard accessibility using vibrating keys

(75) Inventors: Hypatia Rojas, Round Rock, TX (US); Brenda Stevens Ryan, Austin, TX (US); Barbara Elizabeth Wang, Austin, TX (US)

Correspondence Address: Mark D. Simpson, Synnestvedt & Lechner LLP, 2600 Aramark Tower, 1101 Market Street, Philadelphia, PA, 19107-2950, US

(73) Assignee: International Business Machines Corp., Armonk, NY

(21) Appl. No.: 10/392,760

(22) Filed: Mar. 19, 2003

(51) Int. Cl. G09G 5/00

(52) U.S. Cl. 345/168

(57) ABSTRACT

A keyboard in which one or more individual keys of the keyboard can be vibrated selectively. Thus, when a particular combination of keys or a single key needs to be activated, the user can identify the required key(s) by touch rather than by vision.

### BACKGROUND OF THE INVENTION

1. Field of the Invention

This invention relates in general to data processing systems and in particular to data entry systems such as computer keyboards.

2. Description of the Related Art

A keyboard is that part of a computer system that resembles a typewriter keyboard and enables a user to control certain aspects of the computer. All computer keyboards include a standard set of manipulatable keys mounted in a keyboard housing that can be independent from the system with which it operates (e.g., a typical desktop computer keyboard) or that is integrated with the system itself (e.g., a typical laptop computer keyboard). Each key typically corresponds to a particular letter, number, symbol, or function. Each key on a typical keyboard comprises a combination of a plastic keycap, a tension mechanism that suspends the keycap but allows it to be pressed down, and an electronic mechanism that records the key press and key release.

Typically, a character or series of characters are printed on the face of the keycap to identify the function of that particular key. Most keys are multi-function keys, meaning that they can be toggled (shifted) between two or more operations (e.g., upper case “A” and lower case “a” the number “7” and the symbol “&”, etc.) typically through the use of a shift key.

Some keyboards are equipped with keys that include electrical wiring extending up into the keycap to illuminate a lamp or other indicator mechanism in the key. An example of such a key can be found in the Powerbook Ti made by Apple Computers, which includes LEDs in the “CAPS LOCK” keycap to show if the CAPS LOCK function is engaged. Others have developed back lighting systems for delivering light to the keycap area of the keyboard. U.S. Pat. No. 5,034,602 to Garcia, Jr. et al. teaches an optically active keyboard having key members, each with a keycap having illuminated symbols at the keycap surface. Keypads, a cousin of the keyboard, have been provided with vibrators to produce tactile feedback sensed by the user whenever the pad is touched, so that the user is given a tactile indication that the pad has been touched. The need for artificial tactile response with keypads is due to their lack of keys having mechanical travel that can be sensed by the user. An example of this technology can be found in U.S. Pat. No. 5,977,867 to Blouin.

Today's keyboards contain many additional keys beyond the traditional alpha-numeric keys. A typical desktop keyboard may have over 100 keys, and a typical laptop keyboard may have 85 keys as well as dedicated keys for functions such as volume control. Function keys, “Page Up” and “Page Down” keys, “Home”, etc. all find their place on typical keyboards in use today. The “CTRL” and “ALT” keys act like additional “SHIFT” keys, designating different functions to keys or sequences of keys when they are depressed simultaneously with the “CTRL” and/or “ALT” keys.

While the use of function keys and shift-type keys give designers the ability to increase the number of keys on a keyboard and/or maximize the use of keyboard space, such keyboard systems still have drawbacks. For example, function keys are typically labeled simply “F1”, “F2”, “F3”, . . . , etc. and thus require the user to remember the function performed by the function key or use a separate template to refer to when using the function keys. This makes the use of function keys more difficult, particularly for someone not familiar with the function keys' operations.

Most software comes with accessibility features that enable a keyboard to be utilized more efficiently or more easily for that particular program. For example, many people prefer keyboard operations, e.g., CTRL, ALT, DELETE for “reboot”, over the use of a mouse selection to perform the same operation performed by the keyboard operations. To eliminate the need to simultaneously hold the CTRL, ALT and DELETE keys down to perform the reboot function, “sticky keys” have been developed which allow the user to activate the keys in succession rather than simultaneously, based upon a setting made by the user. Other accessibility features are also available. For example, “toggle keys” enable users to hear tones when the CAPS LOCK, NUM LOCK, or SCROLL LOCK keys are pressed. The keyboard shortcut to enable toggle keys is to hold down the NUM LOCK key for 5 seconds.

Visually and/or hearing impaired persons in particular may wish to take advantage of sticky keys, toggle keys, or other keyboard options as opposed to using a mouse to activate functions. However, locating the appropriate keys can be difficult. In addition, users of learning tools and games may wish to use the keyboard without having to look at the keys. Accordingly, it is desirable to have a keyboard that alerts a user by a tactile indication as to the location of specific keys, e.g., to identify keys and/or key combinations that perform various functions.

### SUMMARY OF THE INVENTION

The present invention is a keyboard in which one or more individual keys of the keyboard can be vibrated selectively. Thus, when a particular combination of keys or a single key needs to be activated, the user can identify the required key(s) by touch rather than by vision.

### BRIEF DESCRIPTION OF THE DRAWINGS

FIG. 1 depicts a keyboard layout for a typical IBM ThinkPad® laptop computer;

FIG. 2 illustrates a vibrating keycap in accordance with the present invention; and

FIG. 3 is a flowchart illustrating steps performed in accordance with the present invention to achieve the functionality thereof.

### DETAILED DESCRIPTION OF THE PREFERRED EMBODIMENTS

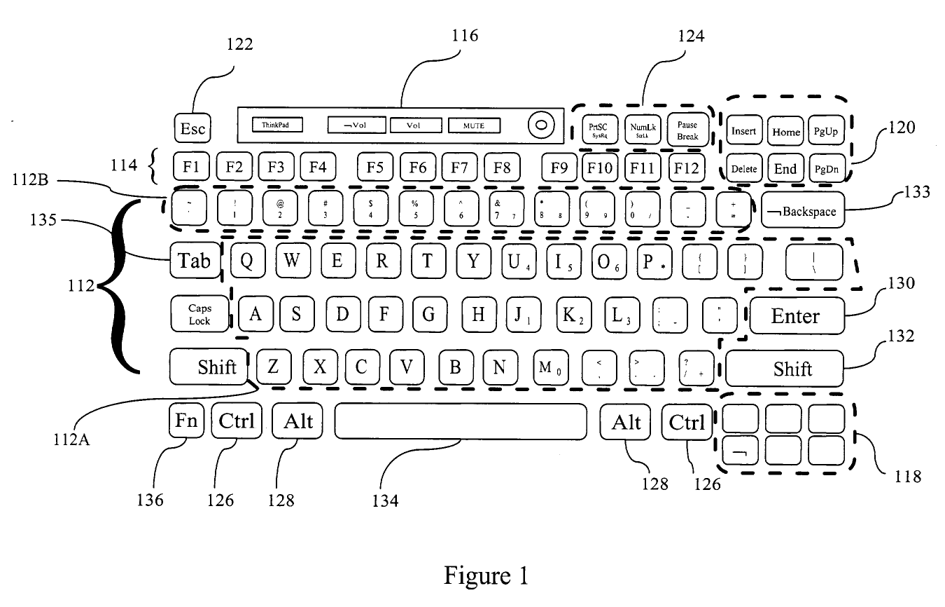

With reference now to the figures, in FIG. 1, there is depicted a keyboard layout for a typical IBM ThinkPad® laptop computer. It is understood that this particular keyboard configuration is illustrated for purposes of example only, and that the present invention is equally applicable to any keyboard layout.

Referring to FIG. 1, keyboard 110 includes a block of alphanumeric keys 112, a group of function keys 114, control keys 116, cursor-control keys 118, screen/text control keys 120, “escape” key 122, and miscellaneous operational keys 124. The alphanumeric block 112 includes the alphabet/primary-punctuation keys 112A; the numeric keys 112B; and primary control keys comprising “Ctrl” keys 126, “Alt” keys 128, the “Enter” key 128, shift keys 132, the “Backspace” key 133, the space bar 134, and the “Tab” key 135.

The Ctrl keys 126, Alt keys 128, and shift keys 132 provide, in a well known manner, the ability to provide alternate operation for various keys along the keyboard. The Enter key 130, space bar 134, Backspace key 133, and Tab key 135 function in a well known manner to control the movement of a cursor displayed on a system to which the keyboard is operatively coupled. In addition, the ThinkPad® computer also has a “Fn” key 136, the operation of which will be described below.

The function keys 114 are software-specific, that is, they operate based upon the program presently running on the computer. For example, in a word processing program, pressing the “F1” function key might bring up a help menu; pressing the Ctrl key 126 with the “F1” key might run a spell-checking function; pressing the Alt key 128 with the “F1” key might run a Thesaurus function; and pressing the Shift key 132 with the “F1” key might perform a grammar checking function. The same keys activated during the operation of a computer game might cause the firing of a weapon used in the game; the pausing of game play; display of a “save” menu; and display of the current high score, respectively. The Ctrl keys 126 and Alt keys 128 function in a manner similar to the shift key 132; that is, by depressing the control key in connection with the simultaneous depressing of an alpha-numeric key or function key, the depressed key will perform a different function than its ordinary function, assuming that the program being operated has been configured to operate in this manner. Thus, the function keys 114 provide for customizable functions based on the program, the Ctrl keys 126 and Alt keys 128 provide the ability to expand the function of all keys beyond the designation imprinted upon the keycap, and the Shift keys 132 provide dual functionality to most “regular” keys and additional functionality to the function keys 114.

The Fn key 136 is provided on the ThinkPad® computer to provide additional computer-specific functionality options not available using a function key or a function key in connection with the Shift, Ctrl, or Alt keys. Thus, in the example above, where the “F1” key and the Shift, Ctrl, and Alt keys are used to provide four functions for one key, the addition of the Fn key 136 extends that to a fifth function. For example, the F4 key of a ThinkPad® computer is imprinted with a small symbol of a computer screen and a crescent moon, in addition to the F4 designation. When the F4 key is pressed simultaneously with the Fn key, this puts the computer screen into a sleep mode that saves battery power. Obviously, designers could add additional keys similar to the Fn, Ctrl, Alt, and Shift keys and thereby obtain more functionality. However, typically it is more desirable to reduce the number of keys while maintaining or increasing the functionality available.

Control keys 116 are simply special purpose pre-designated keys to perform specific operations that a user of the PC might be called upon to use quickly, though not necessarily frequently. These keys are computer-specific and function the same regardless as to which program is running on the system at the time. These controls include volume controls and one-button access to help information regarding ThinkPad® computers.

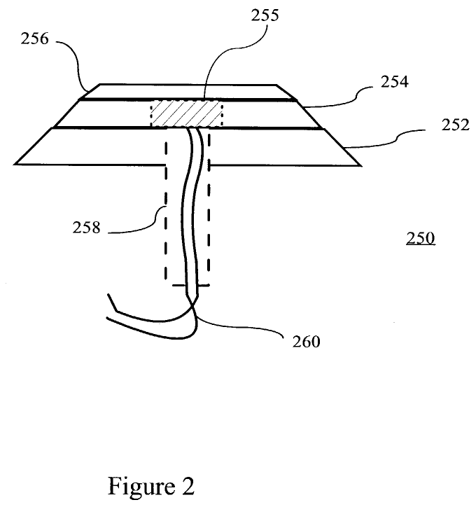

Referring now to FIG. 2, a vibrating keycap 250 in accordance with the present invention is illustrated. Referring to FIG. 2, the keycap 250 comprises a lower cap 252 having a plunger 258 connected thereto in a well-known manner. This plunger/cap combination is a well-known configuration for typical keycaps used in keyboards. In accordance with the present invention, a vibrating-element layer 254 is situated atop the lower cap 252 and includes a vibrating element 255 that receives power and control functions via wires 260. Wires 260 extend through the plunger 258 from the vibrating element layer 254, thereby placing them in appropriate location to receive power and control signals when connected to a power/control source such as a CPU. Vibrating-element 255 can comprise any vibrating element such as the Model FM23 Pager Motor, manufactured by Sanwa, described in U.S. Pat. No. 5,036,239 issued to Yamagochi. Other vibration devices by Sanwa or other manufacturers can also be used. Further, if desired, the entire vibrating element layer 254 can comprise vibrating element 255 if desired.

A plastic cover 256 can be affixed to the vibrating element layer 254 and/or to the lower cap 252 using any known method, including glues, adhesives, or by providing an interlock between the plastic cover 256 and the lower cap portion 252 in such a way as to hold the vibrating element layer 254 therebetween. The example shown in FIG. 2 is merely one example of a method for providing individually vibrating keycaps. It is understood that any known means for constructing a keycap and including therein a vibrating element 255 will suffice for the purpose of the present invention.

In a preferred embodiment, wires 260 connect the vibrating element 255 to a CPU running the computer to which the keyboard is attached. The vibrating element 255 generates a mechanical vibration sensed by the user, under control of the CPU. The CPU also controls the vibration frequency, amplitude and pulse length.

The ability to activate/deactivate the “vibration mode” of the keyboard of the present invention can be implemented using any known method for selection of hardware/software options in a processing environment. For example, the user of the system/method of the present invention can select a “key vibration” option from a preferences menu in a well-known manner to enable (or disable) the key vibration option. Other methods for activating/deactivating the key vibration option will be apparent to one of ordinary skill in the art.

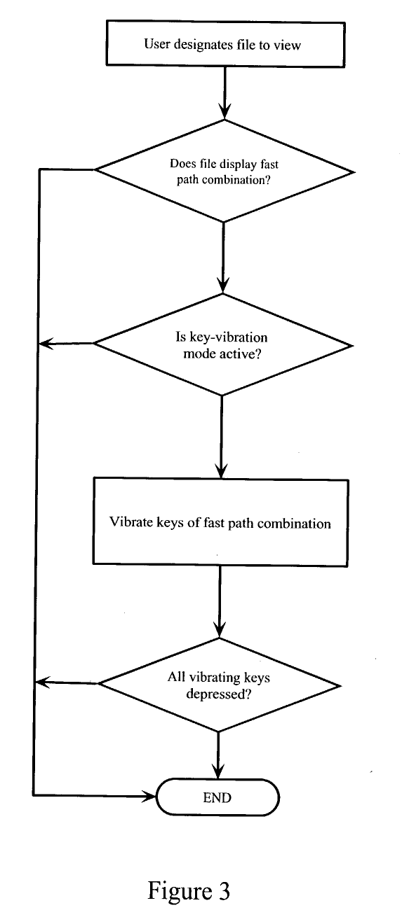

FIG. 3 is a flowchart illustrating steps performed in accordance with the present invention to achieve the functionality of the present invention in connection with fast path key combinations (e.g., CTRL, ALT, DEL to reboot). At step 300, the user designates a file for viewing. This may be a text file, a program file, an image file, or any other file available on the computer. For example, in response to a query in a “HELP” menu asking how to trigger a system reboot, the user might be shown a display window with the text: “To reboot the computer, simultaneously depress the CTRL, ALT, and DEL keys.” If the user is visually impaired and has a text-to-speech system installed, this text would be “spoken” to the user.

At step 302, a determination is made as to whether or not the file that the user has selected for viewing contains a fast path key combination (in this example). If the file that the user is viewing does not contain a fast path key combination, the process ends and the user continues using the computer in a normal manner.

If, however, at step 302, a determination is made that the user is viewing a fast path key combination, then at step 304, a determination is made as to whether or not the “key vibration option” is active. If the key vibration mode is not active, the process proceeds to the end where the program is used in a normal manner. However, if the key vibration mode is active, then at step 306, the keys forming the fast path key combination (e.g., CTRL, ALT, DEL) are vibrated and remain vibrating until the user activates the key combination. This can be performed by having the CPU identify the key combination being viewed and then initiating the proper signal(s) to the keyboard to cause the keys in the combination to vibrate, and then cease vibrating when they have been properly depressed. The user simply places his or her finger on the keyboard and activates the vibrating keys. Once the keys in the combination have been activated, they cease vibration and the process proceeds to step 310 where the program proceeds normally.

The process described above has been explained with reference to the use of fast path key combinations. It is understood that the vibrating keys of the present invention can find application in any situation whereby a user wishes to have the ability to receive tactile instructions/directions regarding key selection, for example, in an instructional typing program and/or any program being used by a person with visual and/or hearing impairment.

The above-described steps can be implemented using standard well-known programming techniques. The novelty of the above-described embodiment lies not in the specific programming techniques but in configuration of the keyboard to use vibrating keys and the use of the steps described to achieve the described results. Software programming code which embodies the present invention is typically stored in permanent storage of some type, such as permanent storage of the CPU to which the keyboard is connected. In a client/server environment, such software programming code may be stored with storage associated with a server. The software programming code may be embodied on any of a variety of known media for use with a data processing system, such as a diskette, or hard drive, or CD-ROM. The code may be distributed on such media, or may be distributed to users from the memory or storage of one computer system over a network of some type to other computer systems for use by users of such other systems. The techniques and methods for embodying software program code on physical media and/or distributing software code via networks are well known and will not be further discussed herein.

It will be understood that each element of the illustrations, and combinations of elements in the illustrations, can be implemented by general and/or special purpose hardware-based systems that perform the specified functions or steps, or by combinations of general and/or special-purpose hardware and computer instructions.

These program instructions may be provided to a processor to produce a machine, such that the instructions that execute on the processor create means for implementing the functions specified in the illustrations. The computer program instructions may be executed by a processor to cause a series of operational steps to be performed by the processor to produce a computer-implemented process such that the instructions that execute on the processor provide steps for implementing the functions specified in the illustrations. Accordingly, FIGS. 1-3 support combinations of means for performing the specified functions, combinations of steps for performing the specified functions, and program instruction means for performing the specified functions.

Although the present invention has been described with respect to a specific preferred embodiment thereof, various changes and modifications may be suggested to one skilled in the art. For example, although the embodiments described above are explained with reference to a mechanical computer keyboard, it is understood that the present invention is equally applicable to any system in which key elements are used and in which it might be desirable to prompt a user as to which key(s) to activate, such as keypads, cell phones, PDA's, game controllers, etc. It is intended that the present invention encompass such changes and modifications as fall within the scope of the appended claims.

We claim:

1. A configurable keyboard, comprising:
a keyboard housing;
a plurality of keys, mounted in said keyboard housing, with one or more of said keys having selectively-vibratable keys; and
a storage device, operatively connectable to said plurality of keys, storing program instructions executable to configure one or more of said selectively-vibratable keys to be vibrated to indicate a predetermined keystroke selection.

2. A configurable keyboard as set forth in claim 1, wherein said predetermined keystroke selection comprises one or more keys which, when activated, perform a predetermined operation.

3. A configurable keyboard as set forth in claim 2, wherein said storage device further stores program instructions executable to enable a user of said keyboard to select the availability or inavailability of the selective vibration of the selectively-vibratable keys.

4. Computer-readable code stored on a computer-readable medium for configuring a keyboard having selectively-vibratable keys to allow tactile identification of keys to be selected to perform a specified function, comprising:
first subprocesses for enabling controlled vibration of said selectively-vibratable keys; and
second subprocesses for enabling one or a combination of said selectively-vibratable keys to be vibrated to identify keys to be activated to perform the specified function.

5. Computer-readable code stored on a computer-readable medium for configuring a keyboard according to claim 1, wherein activation of said vibrated keys causes a processor to which the keyboard is attached to perform a predetermined operation.

6. A processing system, comprising:
a central processing unit;
a storage medium coupled to said central processing unit;
a keyboard coupled to said central processing unit, said keyboard having selectively-vibratable keys; and
program instructions stored on said storage medium, said program instructions executable to configure one or more of said selective-vibratable keys to be vibrated to indicate a predetermined keystroke selection.

7. A method of identifying keys to be selected on a keyboard to perform a specified function, comprising the steps of:
providing selective vibration capability to one or more keys of said keyboard; and
vibrating one or more of said keys to identify keys to be activated to perform the specified function.
